(19) United States
(12) Patent Application Publication
(10) Pub. No.: US 2008/0144993 A1
(43) Pub. Date: Jun. 19, 2008

(54) Optimisation of the Number and Location of Regenerative or Non-Regenerative Repeaters in Wavelength Division Multiplex Optical Communication Links

(76) Inventors: Giulio Bottari, Livorno (IT); Fabio Cavaliere, Vecchaino (IT)

Correspondence Address: COATS & BENNETT, PLLC, 1400 Crescent Green, Suite 300, Cary, NC, 27518, US

(21) Appl. No.: 11/572,467

(22) PCT Filed: Jul. 20, 2005
(86) PCT No.: PCT/EP05/53530

§ 371 Date: Dec. 13, 2007

(30) Foreign Application Priority Data
Jul. 22, 2004 (IT) MI2004A 001481

(51) Int. Cl. G02B 6/12

(52) U.S. Cl. 385/14

(57) ABSTRACT

A method for optimisation of the number and location of regenerative or non-regenerative repeaters in a WDM link made up of N spans connected in a succession of N−1 intermediate sites to form link sections separated by sites containing regenerative repeaters, comprises a step for defining the number of regenerative repeaters needed and giving them a first location. Said step comprises the phases of defining targets OSNRs (VOSNRT) as a function of the number of spans and the type of fibre used in the spans, and defining a possible section between an initial site and a final site, appraising a metric function VM for said possible section obtained as a function of the difference between the OSNR (VOSNR) at the final end of the first span of said possible section and the corresponding target OSNR (VOSNRT) given by the number of spans in said possible section. If the appraised metric function VM satisfies an established quality parameter, add to the possible section the following span in the link and again appraise the metric function for said new possible section obtained as a function of the difference between the OSNR (VOSNR) at the final end of the first span of the possible section and the corresponding target OSNR (VOSNRT) with the new number of spans in the possible section. Said steps are repeated iteratively while adding spans to the possible section until the metric function VM no longer satisfies the quality parameter and one returns at the end site preceding the last span added and positions a regenerator in said site. The procedure is repeated until the end of the new section is identified or to exhaustion of the spans of the link.

The present invention relates to a method of optimisation of the number and location of regenerative or non-regenerative repeaters in optical communication links, in particular links in Wavelength Division Multiplex (WDM) optical communication systems.

For equipment suppliers and telecommunications operators alike, it is important to be able to optimise the use of active (i.e. those which provide gain) repeaters along the network links to reduce the investments needed and be more competitive in the market.

The standard way of estimating the performance of links of a multi-channel WDM system is to measure or estimate the Bit Error Rate (BER) of the digital channels transmitted on separate optical carriers (wavelengths). Unfortunately, there is no easy way to associate the BER with the characteristics of the link (for example fibre attenuation, chromatic dispersion, polarization mode dispersion, effective area) or the transmitted channels (for example bit-rate, modulation format, pulse-shape, channel spacing etc).

Optimisation of the location of repeaters requires a check of the link feasibility to be repeated for all the possible permutations of optical amplifiers (non regenerative repeaters) and 3R regenerators (regenerative repeaters) in order to find the solution of lowest cost. This is practically impossible and currently network optimisation is based on the skills and experience of designers rather than any automatic or defined procedure. As a result the experience of the designers becomes crucial but difficult to appraise.

A generic WDM network comprises a number of constituent components these include: a WDM Transmit Terminal, a WDM Receive Terminal, a WDM Link, and an OADM Node. Each of these components will now be defined.

A WDM Transmit Terminal is defined as a network node where several digital communication channels (client or tributary channels) modulate different optical carriers (wavelengths), are frequency multiplexed to form an aggregate optical signal (the WDM signal), and optically amplified before coupling the WDM signal into the optical transmission fibre (transmission medium).

A WDM Receive Terminal performs the reverse operation to that of a Transmit Terminal, that is demultiplexing the received WDM signal, sending each optical channel over a different path and separating the communication channel from the associated wavelength carrier.

A WDM Link is everything between the Transmit Terminal and Receive Terminal and includes the optical fibre spans and any equipment necessary for ensuring sufficient signal quality at the Receive Terminal.

An OADM (Optical Add Drop Multiplexer) Node selectively divides the optical channels making up the input WDM signal into three different paths. A first subset of channels (Express channels) pass through the node without undergoing any processing. A second subset of channels (DROP channels) are demultiplexed from the WDM signal and terminated in the node itself, as in a Receive Terminal. Finally, a third subset of channels (ADD channels) are added to the WDM signal as in a Transmit Terminal. Clearly, to avoid wavelength contention, limitations have to must be respected for correct operation of the WDM link. For example, the wavelengths of ADD channels has to be different to those of Express channels and the total number of channels must not exceed the maximum number of channels allowed by the Terminal nodes.

The location of the Terminal and OADM nodes in a network are usually known and depend on the distribution of the tributary channels in accordance with a traffic matrix specified by the network operator (often the operator will also own the network). However, the location of other types of components (such as passive connections e.g. fibre splices, optical amplifiers, 3R regenerators) are not established in advance but are usually agreed between the operator and the equipment supplier. It is important to note that while the location of the Terminal and OADM nodes meets the needs of the operator, the interest of the operator is to minimize the rest of the equipment to reduce capital investment. In contrast the supplier's responsibility is to locate passive connections, optical amplifiers and 3R regenerators to prevent excessive degradation of the signal caused by propagation in the optical fibres and to meet a quality specification whilst keeping costs to a minimum.

To understand how the costs are distributed, it is instructive to outline the function of an optical amplifier and a 3R Regenerator.

The progressive attenuation experienced by the signal propagating in an optical fibre necessitates the use of optical amplifiers for restoring the same optical power level as at the input to the fibre. An optical amplifier is an example of a non-regenerative repeater. In a network having many spans and a cascade of optical amplifiers, the gain of each amplifier should ideally exactly compensates the loss in the preceding fibre span. Unfortunately, the amplifier is not a perfect device. Firstly, an amplifier introduces amplified spontaneous emission (ASE) noise in addition to providing the required optical gain. When there is a plurality N of cascaded optical amplifiers, each of them adds a certain amount of ASE noise implying a gradual degradation of the OSNR (Optical to Signal Noise Ratio) along the fibre link. The amplifier noise is specified by its Noise Figure. Secondly, the gain of an optical amplifier is not flat over the entire operating band (wavelength range) and some wavelength channels are consequently amplified more than others. This problem worsens when several amplifiers are connected in cascade. The amplifier's gain flatness is specified by its Gain Flatness.

Optical amplifiers can only compensate for attenuation and other impairments experienced during transmission such as chromatic dispersion, polarization mode dispersion, and other non linear effects which cause distortion of the channels accumulate cannot be compensated by optical amplifiers alone. Again such problems accumulate along the path and consequently as the distance of the link increases, other components such as one or more 3R Regenerators are required to ensure the required quality of service at the receiver.

For the purposes of this document a 3R Regenerator can be seen as a Receive Terminal followed by a Transmit Terminal in which the channels are demultiplexed, undergo opto-electrical O/E conversion, are electrically processed, undergo electro-optical E/O conversion and are finally multiplexed and re-launched into the optical fibre. Regeneration allows restoration of the correct power, shape and re-timing of the pulses making up the binary signal associated with each WDM channel. A 3R regenerator is a regenerative repeater. In contrast as described above an optical amplifier is a non regenerative repeater.

It is now easy to understand where the costs are concentrated; current optical amplifiers allows amplification of the entire DWDM signal using a single device whilst the 3R Regeneration requires a sequence of complex operations and, in particular, O/E/O conversion has to be performed on each channel and thus requires a number of devices corresponding to the number of channels transported by the WDM signal. The cost of each O/E/O conversion is comparable with that of an optical amplifier, and hence the cost of a 3R Regenerator is comparable to the cost of a single amplifier multiplied by the number of WDM channels. In conclusion, the use of 3R regenerators is to be minimised as much as practicable.

To date, optimisation in the location of active (those which provide gain) repeater elements whether non regenerative (such as optical amplifiers) or regenerative (such as 3R regenerators), along the links in a network to keep a predetermined signal quality, are based on the personal skill and experience of designers rather than on an automatic and rigorous procedure. Such a method does not necessarily ensure the optimal arrangement in terms of costs.

The general purpose of the present invention is to remedy the above mentioned shortcomings by making available a method of optimising, in an automatic and rigorous manner, the number and position of repeaters whether regenerative or non regenerative in a WDM link.

In accordance with the present invention the method of the invention in the first place positions non regenerative repeaters (optical amplifiers) and regenerative repeaters (3R regenerators) in such a manner as to minimize the number of 3R regenerators representing the greatest cost of the system. Then once the regenerators have been positioned the method tries to reduce the number of optical amplifiers while continuing to ensure sufficient quality of the WDM channels.

According to the present invention there is provided, as defined Claim 1, a method for optimisation of the location of regenerative or non regenerative repeaters in a WDM link made up of N spans connected in a succession of N−1 intermediate sites to form link sections separate from sites containing regenerative repeaters and comprising a step for defining the number of regenerative repeaters needed and giving them a first location with said step including the phases of:
defining target OSNRs (V_{OSNRT}) as a function of the number of spans and the type of fibre used in the spans;
defining a possible section between an initial site and a final site, appraising a V_{M} metric function for said possible section obtained as a function of the difference between the OSNR (V_{OSNR}) at the final end of the first span of said possible section and the corresponding target OSNR (V_{OSNRT}) given by the number of spans in said possible section;
if the appraised metric function V_{M} satisfies an established quality parameter, add to the possible section the following span in the link and again appraise the metric function for said new possible section obtained as a function of the difference between the OSNR (V_{OSNR}) at the final end of the first span and the corresponding target OSNR (V_{OSNRT}) with the new number of spans in the possible section; and
repeating iteratively said steps while adding spans to the possible section until the metric function V_{M} no longer satisfies the quality parameter, returning to the site at the end of the span preceding the last span added and position a regenerator in said site, so as to terminate the section in question, and make said site as a new initial site of a possible section following the section just terminated and repeat the procedure by adding spans to the possible section until identifying the end of the new section or exhaustion of the spans of the link.

Embodiments of the invention are defined in the sub-claims appended hereto.

In order that the innovative principles of the present invention and its advantages compared with the prior art are better understood, there is described below a possible method, by way of example only, applying said principles.

For the purposes of the following method it is assumed that the link has (N+1) sites: that is two terminals and (N−1) intermediate sites. N is known and is the number of locations that can house an optical amplifier, a regenerator, an OADM or a splice (passive connection) for connecting adjacent segments of optical fibre. N is also the number of spans in the link.

The portion of the link that runs between two consecutive regenerators is referred to as a Regeneration Section or just section. More generally a section can be defined between the two terminals of the link (if there is no regenerator present); between a terminal and a regenerator; or between two consecutive regenerators.

The position of the sites, the intermediate lengths of optical fibre and the corresponding spans lost are given parameters. There will be a series of Span Attributes (for example, in an array of N elements) such as:

| | | |
|---|---|---|
| V_{E} | [dB] | End of Life Attenuation (EOLA) |
| V_{SM} | [dB] | Span margin |
| V_{L} | [km] | Span length |
| V_{F} | | Span fibre type. |

To keep a trace of the type of element that in accordance with the present method is arranged in each site along the link, it is also possible to define an V_{S} array of N−1 Site Attributes. This is an array of (N−1) integers where the i^{th} element can be for example:

1=Splice (passive connector)

### 2=Amplifier

### 3=3R Regenerator

### 4=Add Drop Multiplexer (OADM).

In accordance with the present method, some metrics are defined for multispan WDM links while comparing them with target figures in a look-up table. Regenerators and amplifiers are added step by step in accordance with a well-defined procedure until the metrics become equal or greater than the target metrics. In accordance with another aspect of the present invention, a method for automatically finding the solution of optimal positioning of the network elements is proposed using a limited set of parameters. Advantageously, the use of the Optical Signal to Noise Ratio (OSNR) is proposed. All the other transmission defects are considered implicitly defining a target function OSNR of the number of spans and the type of fibre (when the link distance increases, the transmission penalties increase as a result and higher OSNRs are necessary to absorb them). This function can change depending on the implementation of the system and depends on the design rules of the user. A look-up table containing the target OSNRs like the following example is defined:

| | Fibre type 1 | Fibre type 2 | Fibre type 3 | Fibre type 4 | . . . | Fibre type n |
|---|---|---|---|---|---|---|
| 1 span | OSNR_{target} 1, 1 | OSNR_{target} 2, 1 | OSNR_{target} 1, 3 | OSNR_{target} 1, 4 | . . . | OSNR_{target} 1, n |
| 2 spans | OSNR_{target} 2, 1 | OSNR_{target} 2, 2 | OSNR_{target} 2, 3 | OSNR_{target} 2, 4 | . . . | OSNR_{target} 1, n |
| 3 spans | OSNR_{target} 3, 1 | OSNR_{target} 3, 2 | OSNR_{target} 3, 3 | OSNR_{target} 3, 4 | . . . | OSNR_{target} 1, n |
| . . . | . . . | . . . | . . . | . . . | . . . | . . . |
| m spans | OSNR_{target} m, 1 | OSNR_{target} m, 2 | OSNR_{target} m, 3 | OSNR_{target} m, 4 | . . . | OSNR_{target} m, n |

Let us call said table of target OSNRs [dB], V_{OSNRT}. Each column of the matrix refers to a fibre type among those used most commonly in optical networks (SMF, LEAF™, TrueWave™). Each row of the matrix refers to a number of spans; in the first row we find the target OSNRs for links with one span, in the second the targets OSNRs for links with two spans and so forth. A realistic maximum number of rows is approximately 40 corresponding to 40 fibre spans.

The method in accordance with the present invention works advantageously in three steps, that is:

a) if appropriate, join short adjacent spans by means of passive connectors/splices;
b) find the minimum number (N_{R}) of regenerators that make the link feasible; and
c) find the optimal positions for these regenerators.

The first step a) can be optional though it is preferable to perform it, if for no other reason than, to reduce the number of sites on which it is then necessary to carry out the next two steps c) and d).

Again, in accordance with the present invention, a fourth step d) can be advantageously appended, that is:

d) reduce the number of amplifiers used.

Advantageous implementations of the individual steps a) to d) of the method realized in accordance with the various aspects of the present invention are now described.

In the first step a) (that is join short adjacent spans by splices or passive connectors if feasible) two or more short spans are joined by means of a splice before allocating/positioning the regenerators.

The following parameters are defined:

| | |
|---|---|
| L_{S} | Splice loss [dB] |
| G_{MIN} | Minimum Gain among available amplifiers [dB] |
| G_{MAX} | Maximum Gain among available amplifiers [dB] |
| V_{E} | End Of Life Attenuation of the span (EOLA) [dB] |
| [G_{MIN}, G_{MAX}] | Optical amplifier gain range |

Two consecutive spans will have:

| | |
|---|---|
| V_{E}[i] | Loss of the i^{th} span |
| V_{E}[i + 1] | Loss of the (i + 1)^{th} span. |

If these two spans (i and i+1) are joined by a splice with loss L_{S}, the total loss will be:

V_{E}[i]+V_{E}[i+1]+L_{S}.

There are three possible cases of such total loss.

### Case 1

V_{E}[i]+V_{E}[i+1]+L_{S}<G_{MIN}

That is, if two (or more) adjacent spans have a total EOLA (including splice loss) less than or equal to the minimum gain of the amplifier G_{MIN}, it is possible and appropriate to connect these spans before moving on to the next step of the method.

### Case 2

G_{MIN}<=V_{E}[i]+V_{E}[i+1]+L_{S}<=G_{MAX}

If two or more adjacent spans have a total EOLA, including slice losses, within the Amplifier Gain Range [G_{MIN}, G_{MAX}], it is necessary to evaluate case by case whether it is appropriate to join these spans by a splice. At this point it is instructive to summarize how OSNR is calculated:

$$OSNR = 10 \cdot Log ( \frac{{p}_{channel}}{{p}_{ase}} )$$

where P_{channel} and Pₐₛₑ are respectively the channel and ASE noise powers in linear units. The denominator is a function of G:

Pₐₛₑ(G)=k·nf(G)·10^{G/10}

where G is the optical amplifier gain in [dB], nf is the optical amplifier noise figure in linear units, k is a constant term which depends on Planck's constant, work frequency and the optical bandwidth.

In general, G is equal to EOLA so that the amplifier compensates for the whole span loss. If EOLA is less than G_{MIN}, the span is loaded with an attenuator (pad) in order to reach the G_{MIN} figure. In other words, the spans will be joined if:

G=Max(G_{MIN},EOLA).

In accordance with one aspect of the present invention, to evaluate the suitability of joining the two spans, the solution is selected such as to minimize the Pₐₛₑ. In other words, the spans will be joined if:

P_{ase Join}<P_{ase Not Join}

which is equivalent to:

Pₐₛₑ(Max(G_{MIN},V_{E}[i]+V_{E}[i+1]+L_{S}))<Pₐₛₑ(Max(G_{MIN},V_{E}[i]))+Pₐₛₑ(Max(G_{MIN},V_{E}[i+1]))

but according to the starting hypothesis of case 2:

G_{MAX}>=V_{E}[i]+V_{E}[i+1]+L_{S}>G_{MIN}

hence:

Pₐₛₑ(V_{E}[i]+V_{E}[i+1]+L_{S})<Pₐₛₑ(Max(G_{MIN},V_{E}[i]))+Pₐₛₑ(Max(G_{MIN},V_{E}[i+1]))

If this condition is verified, the two adjacent spans can be joined. If it is not verified, a passive joint is not possible.

### Case 3

G_{MAX}<V_{E}[i]+V_{E}[i+1]+L_{S}

If two (or more) adjacent spans have a total EOLA including the splice losses greater than the maximum amplification gain, the spans cannot be joined using a passive connection.

After performing the first step a) and joining all the spliceable spans, one can then go on to the second step b) (finding the minimum number N_{R} of regenerators that make the link feasible). This second step applies a recursive procedure that considers each site starting from the Transmit site up to the Receive site. An amplifier is placed in each available site (except those which have been joined by passive connection/splice in step a) of the link. Advantageously, two pointers P₁ and P₂ are used to select the sites in the link during the recursive procedure. P₁ points to the site at the beginning of the section under study and would initially be the Transmit site and subsequently the site of the regenerator at the beginning of the link currently under study. P₂ is also initially set to correspond to P₁ and is then incremented (conceptually this can be envisaged as moving from the site indicated by P₁ at the start of the link along the link to the next site/s) until it reaches a site at which a regenerator is to be allocated and this ends the section under study. As is described below P₁ is set to correspond to the value of P₂ and the site for the regenerator determined in a like manner until all regenerators are allocated.

To keep track of the position of the regenerators, it is advantageous to define an array V_{R} whose size is (N+1), i.e. an element (logical) for each site including the terminals. The first and last elements are set to “True” while the other elements are set to “True” if the relevant site contains a regenerator but otherwise they are set to “False”.

For application of the second step b), the following link attributes are defined.

| | |
|---|---|
| V_{OSNR} | OSNR at the end of the sections. This array contains an element |
| | for each regenerator section. The first element is the OSNR at |
| | the end of the first section and so on. |
| V_{M} | Metric parameter [dB] for each regenerator section; the |
| | OSNR figures at the end of each section minus the associated |
| | OSNR target. It is an array with (N_{R} + 1) elements. |
| V_{OADM} | A fixed correction term which increases the target OSNR |
| | whenever an OADM is present. |

In the second step b) the method of the present invention works in accordance with the following nine sub-steps.
1. Pointers P₁ and P₂ are placed on the transmit terminal (Tx).
2. Pointer P₂ moves to the first (next) site.
3. The metric for the section from P₁ to P₂ is evaluated:

V_{M}[1]=V_{OSNR}[1]−V_{OSNRT}[1,fibre type]−V_{OADM}

where

| | |
|---|---|
| V_{M}[1] | is the metric of the first (current) section, |
| V_{OSNR}[1] | is the OSNR at the end of the first (current) section, |
| V_{OSNRT}[1, | is the target OSNR for a section which contains just one span |
| fibre type] | of the particular type of fibre, and |
| V_{OADM} | is a constant term if the site pointed to by P₂ is an OADM, |
| | otherwise it is zero. |

4. If V_{M}[1]>0, then P₂ is incremented (moved) to the next (following) site.
5. The metric of the section from P₁ to P₂ is evaluated again (now made up of two spans and therefore uses V_{OSNRT}[2, fibre type] that is the target OSNR for a section containing two spans):

V_{M}[1]=V_{OSNR}[1]−V_{OSNRT}[2,fibre type]−V_{OADM}.
6. If V_{M}[1]>=0, then P₂ incremented (moves) to the following site.
7. This process is iterated until the i^{th} site:

V_{M}[1]=V_{OSNR}[1]−V_{OSNRT}[i,fibre type]−V_{OADM}
becomes negative.
8. When V_{M}<0, then P₂ is decremented by one (moved back) to point to the previous site and a regenerator is allocated there. The first section is thus identified.
9. The pointer P₁ is set to correspond to P₂ to indicate the start site of the second section and the steps 2 to 8 are repeated to identify the second and subsequent sections. A regenerator is positioned at the end of the i^{th} section when V_{M}(i) becomes negative.

This iterative procedure stops when P₂ reaches the final Terminal and thereby determines the number N_{R} of regenerators needed. Thus ends the second step b) of the method.

However, the selected positions for regenerators (memorized in the V_{R} array) are not optimal. Indeed, section 1 to section N_{R} are at the allowed limit of the OSNR. On the contrary, the last section (N_{R}+1) is as a rule above this limit by a considerable amount. This is clear observing the last element of the V_{M} metric vector which is typically the largest. For example, with reference to a link with two sections, it might be:

V_{M}=[0.2 0.4 3.4]

Even though the link is feasible, it is not the best location of the regenerators because the last section has a very large OSNR margin compared to the first two. It would be better to distribute this margin more uniformly while keeping the same minimum number of regenerators.

The third step c) of the method finds the optimal position of the regenerators. In accordance with one aspect of the present invention, said optimal position is sought with an iterative procedure based on minimization of the root mean square V_{RMS} of the elements of the V_{M} metric vector, namely:

$${V}_{RMS} = \sqrt{\frac{{\sum }_{i = 1}^{{N}_{R} + 1} {\underline{V}}_{M}^{2} ( i )}{{N}_{R} + 1}}$$

In other words, starting with the allocation of regenerators determined in step b) of the method (i.e. finding the minimum number of regenerators), the positions of the regenerators will be adjusted to minimize the V_{RMS} of the metric vector by distributing the available margin among all the sections.

To obtain this, step c) of the method will include the following sub-steps:
10. Store the current, initial figure of V_{RMS} in a variable:

V_{RMS}_{_{—}}₀=V_{RMS}
11. The N_{R} regenerator (the last) is moved to the preceding site. A new V_{M} figure and the associated V_{RMS} are calculated.
12. The N_{R} regenerator continues to be moved as long as V_{RMS} continues to decrease. In other words, the position of the N_{R} regenerator that minimizes V_{RMS} is found.
13. The N_{R}−1 regenerator (next to last) is moved to the preceding site. A new V_{M} figure and the associated V_{RMS} are calculated.
14. The N_{R}−1 regenerator continues to be moved as long as V_{RMS} continues to decrease. In other words, the position of the N_{R}−1 regenerator that minimizes V_{RMS} is found.
15. The process is repeated up to the first regenerator (N₁).
16. V_{RMS} is compared with the initial V_{RMS}_{_{—}}0.

Two cases are possible:
V_{RMS}<V_{RMS}_{_{—}}0; in this case, V_{RMS}_{_{—}}0 is set at the V_{RMS} figure and the process is repeated from step 10 starting from the configuration found at the end of step 16.
V_{RMS}=V_{RMS}_{_{—}}0; in this case it is not possible to decrease V_{RMS} further and step c) of the method is ended.

The iterative procedure (V_{RMS}=V_{RMS}_{_{—}}0) being terminated, there is optimal distribution of the regenerators. This distribution can still be stored in the V_{R} array.

At this point, if it is also further desired to optimise the number of amplifiers (which, as stated, have a much lower cost than the regenerators) the next step d) of the method can be applied to optimise the number of amplifiers in the sections.

This last step of the method seeks to reduce the number of optical amplifiers holding the positions of the regenerators. The method acts independently on each section.

In accordance with the present invention, step d) includes advantageously the sub-steps of:
17. Identifying in the first section the amplifier that follows the span with the lowest attenuation (with lowest gain).
18. Replacing it with a splice (passive connector).
19. Calculating the metric of the first section

V_{M}[1]=V_{OSNR}[1]−V_{OSNRT}[2,fibre type]−N_{OADM}[1]·V_{OADM}
where N_{OADM}[1] is the number of OADM present in the first section.
20. If V_{M}[1]>0, repeat steps 17 to 19, otherwise repeat the same steps for the remaining sections.

Having applied steps 17 to 20 to all the sections, the link is completely optimised.

It is now clear that the predetermined purposes have been achieved by making available a method of optimisation of number and the positions of the various regenerative or non-regenerative elements at the sites along the link.

Naturally the above description of an embodiment applying the innovative principles of the present invention is given by way of non-limiting example of said principles within the scope of the exclusive right claimed here. For example, the method can be implemented manually or, more advantageously, by means of an appropriate computer program readily imaginable to those skilled in the art.

1-11. (canceled)

12. A method of optimizing the number and locations of regenerative repeaters in a Wavelength Division Multiplier (WDM) link comprising N spans connecting first and last sites via N−1 intermediate sites, comprising:
obtaining a plurality of target Optical Signal to Noise Ratios (OSNRs), each defined as a function of a number of spans and a type of fiber used in the spans;
defining a first link section comprising one or more spans and evaluating a metric function V_{M} for the first link section, wherein V_{M} is a function of the difference between a OSNR at the end of the first link section and a target OSNR based on a number of spans in the first link section;
if the metric function V_{M} satisfies an established quality parameter, adding a second span to the first link section and evaluating the metric function V_{M} for the new first link section using a target OSNR based on the new number of spans in the new first link section;
iteratively adding spans to the first link section and evaluating V_{M} at each iteration as long as V_{M} satisfies the quality parameter;
when V_{M} no longer satisfies the quality parameter, removing the last-added span from the first link section and then positioning a regenerative repeater at the last intermediate site in the first link section;
defining a the second link section beginning at the last intermediate site in the first link section and comprising one or more spans; and
adding spans to the second link section according to the method steps for the first link section until the terminating end of the second link section is identified by evaluating V_{M}, or until the spans in the WDM link are exhausted.

13. The method of claim 12 wherein the metric function V_{M} is defined as:
V_{M}[1]=V_{OSNR}[1]−V_{OSNRT}[i,fibre type]−V_{OADM}
where

| | |
|---|---|
| V_{M}[1] | is a metric parameter of a current link section, |
| V_{OSNR}[1] | is the OSNR at the end of the current link section, |
| V_{OSNRT}[n, | is a target OSNR for a link section containing n spans, and |
| fibre type] | |
| V_{OADM} | is an appropriate constant term if a terminating site of the |
| | i^{th} span is an Optical Add Drop Multiplexer (OADM), and |
| | zero if the terminating site of the i^{th} span is not an OADM |

and wherein the quality parameter is verified if V_{M}[1]>=0.

14. The method of claim 13 further comprising sequentially storing the V_{M}[i] metric parameters of the link sections in a V_{M} metric vector.

15. The method of claim 14 further comprising optimizing the regenerative repeater positions by:
calculating an initial starting V_{RMS}_{_{—}}₀ value using:
$${V}_{RMS} = \sqrt{\frac{{\sum }_{i = 1}^{{N}_{R} + 1} {\underline{V}}_{M}^{2} ( i )}{{N}_{R} + 1}} ;$$
where N_{R} is the number of regenerative repeaters in the WDM link;
for each regenerative repeater, beginning with the last:
iteratively move the regenerative repeater to the previous intermediate site, and calculate V_{M} and V_{RMS} for the regenerative repeater at that site, to find the position of the regenerator that minimizes V_{RMS}; and
repeat the previous method step until V_{RMS}=V_{RMS}_{_{—}}₀.

16. The method of claim 12 further comprising reducing the number of optical amplifiers in the WDM link while maintaining the positions of the regenerators in the WDM link by, for each link section i:
(a) identifying an optical amplifier in the link section that follows the span having the lowest attenuation;
(b) replacing the identified optical amplifier with a splice;
(c) calculating V_{M}[i] for the section using:
V_{M}[i]=V_{OSNR}[i]−V_{OSNRT}[2,fibre type]−N_{OADM}[1]V_{OADM}
where N_{OADM}[1] is the number of OADMs in the link section; and
(d) repeating steps (a) to (c) if V_{M}[1]>0.

17. The method of claim 12 further comprising determining one or more sites in which a passive link can be used to join adjacent spans, prior to performing any step to locate regenerative repeaters.

18. The method of claim 17 wherein determining one or more sites in which a passive link can be used to join adjacent spans comprises:
calculating a total loss given by the union of two successive spans as:
V_{E}[i]+V_{E}[i+1]+L_{S}
where
V_{E}[i]=Loss of the i^{th} span,
V_{E}[i+1]=Loss of the (i+1)^{th} span,
L_{S}=Loss of the link section; and
comparing the total loss with a minimum gain G_{MIN} between available amplifiers and a maximum gain G_{MAX} between available amplifiers.

19. The method of claim 18 further comprising:
connecting the two successive spans if
V_{E}[i]+V_{E}[i+1]+L_{S}<G_{MIN}; and
not connecting the two successive spans if
G_{MAX}<V_{E}[i]+V_{E}[i+1]+L_{S}.

20. The method of claim 19 further comprising connecting the two successive spans if both of the following conditions are met:
G_{MIN}<=VE[i]+V_{E}[i+1]+L_{S}<=G_{MAX}
and
Pₐₛₑ(VE[i]+VE[i+1]+L_{S})<Pₐₛₑ(MAX(G_{MIN},V_{E}[i]))+Pₐₛₑ(MAX(G_{MIN},V_{E}[i+1])).

21. The method of claim 12 further comprising defining a VOSNRT look-up table that includes the target OSNRs, each column of the table indicating a type of fiber in the link section, and each row of the table indicating a number of successive spans.

22. The method of claim 21 further comprising:
(a) defining two pointers P₁ and P₂, and initially assigning both to the first site in the WDM link, and subsequently assigning both to the intermediate site terminating the previous link section;
(b) moving the pointer P₂ to the next intermediate site;
(c) evaluating the metrics for a j^{th} link section between P₁ and P₂ as follows:
V_{M}[j]=V_{OSNR}[j]−V_{OSNRT}[i,fibre type]−V_{OADM}
where ‘i’ is the number of spans between P₁ and P₂;
(d) repeating steps (b) and (c) until a value of V_{M}[j] falls below zero;
(e) when V_{M}[j]<0, moving P₂ to the previous intermediate site and placing a regenerating repeater at that intermediate site to terminate the j^{th} link section; and
(f) stopping when P₂ reaches a final terminal on the link section.
